(19) United States
(12) Patent Application Publication
(10) Pub. No.: US 2010/0055434 A1
(43) Pub. Date: Mar. 4, 2010

(54) Method to signficantly increase electrophoretic coating thickness and/or to provide a conductive electrophoretically coated surface

(76) Inventor: Morris D. Stillabower, Tipton, IN (US)

Correspondence Address: Delphi Technologies, Inc., M/C 480-410-202, PO BOX 5052, Troy, MI, 48007, US

(21) Appl. No.: 12/231,244

(22) Filed: Aug. 29, 2008

(51) Int. Cl. B32B 5/00; C25D 13/20

(52) U.S. Cl. 428/220; 204/510; 204/484; 428/337

(57) ABSTRACT

A process for electrophoretically coating an electrically conductive substrate involves providing an electrically conductive substrate that is to be electrophoretically coated, pretreating the substrate surface to increase its asperity, and applying an electrophoretic coating composition to the treated substrate surface. The process allows the use of conventional electrophoretic coating compositions and/or processing equipment to achieve thicker coatings and/or to develop electrically conductive electrophoretically coated surfaces employing conventional electrophoretic coating compositions, processing parameters and/or equipment.

### FIELD OF THE INVENTION

This invention pertains to coatings, and more particularly to improved electrophoretic coating techniques, thicker electrophoretic coatings and/or the development of electrophoretic coated surfaces that are electrically conductive.

### BACKGROUND OF THE INVENTION

Electrophoretic coating processes are typically used to apply functional (e.g., corrosion resistant) and/or aesthetic coatings to metal surfaces. It is widely used in the manufacture of vehicle body parts, electrical switch gear, appliances, metal furniture and beverage containers. Electrophoretic coating processes are often more preferred than conventional coating techniques because the electrophoretic coating processes provide very uniform coating thicknesses, allow complex shaped objects to be easily coated, is more conductive to automation, is highly efficient in the utilization of the coating materials, and is more environmentally friendly and safer to use than most other coating technologies.

Electrophoretic processes involve deposition of suspended colloidal particles capable of carrying a charge onto a substrate (electrode) under the influence of an electric field. Typically, the colloidal particles are suspended in an aqueous solution. Materials that may be employed in the coating include polymers, pigments, dyes, ceramics and metals.

Currently, most electrophoretic coating processes have a coating thickness limitation of from about 0.5 mil (12.7 micrometer) to 1 mil (25.4 micrometer). This limitation is due to the fact that most electrophoretic coatings are naturally electrically insulative. Therefore, as the coating thickness increases during the electrophoretic coating process, the electrical resistance between the substrate and a counter-electrode increases, causing a reduction in the plating current and a decreased rate of coating deposition. Eventually, when the coating thickness reaches about 0.5 to 1 mil, the rate of coating deposition becomes neglible.

Thicker electrophoretic coatings are desirable to provide better resistance to ultraviolet light, abrasion, corrosion, and to increase coating life in certain applications.

In order to increase electrophoretic thicknesses, higher voltages have been applied. However, attempts to obtain greater electrophoretic coating thicknesses in this manner have often resulted in an undesirable phenomenon known as “rupture.” The result is a coating with pores or breaks. Such porous coatings are unacceptable from both an aesthetic and functional perspective.

Other attempts to increase electrophoretic coating thicknesses have involved modifying process parameters, such as solution pH, percent solids, tank temperature, voltage set points, use of a voltage ramp to a set point, amp draw, and plating time. Altering these parameters is complex, time-consuming, and has generally resulted in little or no increase in thickness beyond about 1 mil.

Expensive custom or specialty coatings have been proposed. However, such low volume custom blended formulations require dedicated application equipment, since it is generally very difficult, wasteful and even more expensive to switch between conventional coatings and specialty coatings due to the purging and cleaning of equipment needed to avoid cross-contamination between materials.

Electrophoretically conductive electrophoretic coatings are often desirably employed to allow grounding of electronic packaging in electrically sensitive environments requiring chassis grounding. Examples include vehicle engine controls and other vehicle function controls, computers, ESD-sensitive equipment, equipment requiring grounding for RFI/EMC purposes, and grounding of internal circuit board pads to case. Electrophoretic coating is often selected for use in such applications because it provides excellent corrosion resistance. However, commonly employed electrophoretic coating compositions typically form electrically insulative film coatings upon application, rather than the desired electrically conductive surfaces.

In order to obtain electrically conductive, electrophoretically coated surfaces, electrically conductive pigments and other conductivity-modifying compounds, such as carbon or colloidal suspended metal particles (e.g., silver, copper, etc.) are added to form a special or custom electrophoretic paint composition. Custom electrophoretic coating compositions are expensive to make because they are required in lower quantities. They are also expensive to use because they require dedicated equipment, or the use of expensive change-over procedures to prevent cross-contamination with materials used in more conventional electrophoretic coating compositions.

### SUMMARY OF THE INVENTION

The invention, in one of its aspects, allows the use of conventional electrophoretic coating compositions and/or processing equipment to achieve thicker coatings. In addition, the invention allows thicker coatings to be achieved with conventional electrophoretic coating processing parameters (e.g., pH, temperature, voltage, etc.).

In another aspect, the invention allows the development of an electrically conductive electrophoretically coated surface using conventional electrophoretic coating compositions and/or processing equipment. Further, the invention allows electrically conductive electrophoretically coated surfaces to be made using conventional electrophoretic coating parameters, e.g., pH, temperature, voltage, etc.

In accordance with various aspects of the invention, a process for electrophoretically coating an electrically conductive substrate is achieved by providing an electrically conductive substrate that is to be electrophoretically coated, pretreating the substrate surface to increase its asperity, and applying an electrophoretic coating composition to the treated substrate surface.

In accordance with another aspect of the invention, an electrophoretically coated article includes an electrically conductive substrate having a high asperity, and an electrophoretic coating composition applied to the surface having a high asperity, the resulting combination optionally having a plurality of microscopic metallic points of contact exposed at the surface of the electrophoretic coating.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is an elevational cross-sectional view of a typical part that is to be electrophoretically coated.

FIG. 1A is an enlarged view of a portion of the part shown in FIG. 1.

FIG. 2 is an elevational cross-sectional view of a typical part after media blasting in accordance with the invention to increase asperity of the surface, the asperity or unevenness of the surface being exaggerated for clarity.

FIG. 2A is an enlarged view of a portion of the part shown in FIG. 2.

FIG. 3 is an elevational cross-sectional view of the media blasted part of FIG. 2 after a typical electrophoretic application.

FIG. 3A is an enlarged view of a portion of a part shown in FIG. 3.

FIG. 4 is an elevational cross-sectional view of the media blasted and electrophoretically coated part of FIG. 3 after a second electrophoretic application.

FIG. 4A is an enlarged view of a portion of the part shown in FIG. 4.

### DESCRIPTION OF THE PREFERRED EMBODIMENTS

In accordance with certain aspects of the invention, there is provided a low-cost solution for developing thicker electrophoretic coatings on substrate surfaces while using conventional electrophoretic coating compositions. In certain other aspects, the invention provides a low-cost solution for providing electrically conductive electrophoretically coated surface while using conventional electrophoretic coating compositions. In certain aspects, the invention allows “dual coatings” on substrate surfaces to create a two or more layer or laminated electrophoretic coating system. More specifically, a part can be provided with multiple electrophoretic coating layers or lamina that can, for example, have different colors and/or different coating performance specifications. For example, a first electrophoretic coating could be rich in corrosion inhibitors, while a second electrophoretic coating layer could be an abrasion and/or ultraviolet-resistant layer.

As used herein, the term “asperity” refers to or is defined by an unevenness of surface, roughness and/or ruggedness. Flat surfaces, even those polished to a mirror finish, are not truly flat on an atomic scale. Such surfaces have some roughness, with sharp or rugged outgrowths called asperities.

It has been discovered that when media such as iron or other conductive metal beads are used in a blasting technique on the metal parts that are to be electrophoretically coated, pointed asperities having a root mean square height of more than 0.001 inch (1 mil or 25.4 micrometers) in height from the treated surface may be developed. Appropriate techniques for blasting a substrate surface with metal media to develop asperities having a root mean square height that is more than 0.001 inch in height are known and/or can be determined by routine experimentation. Media blasting materials that can be used in the process of the invention are those materials that may be used in a blasting technique to raise asperities on a surface. Such materials are typically comprised of relatively hard particles (i.e., particles that are harder than the surface being treated) that can be propelled at a surface, such as with compressed air (e.g., materials typically used in abrasive blasting processes). Examples of suitable media blasting materials include iron, titanium, diamond, carbide, and ceramic particles. The blasting techniques that may be employed in the invention are similar to conventional processes for treating a substrate to remove mold flash or to texture surfaces and can include any process that has enough energy to achieve the production of asperities by impingement of the media on the substrate surface.

As is well-known in the art, electrophoretic coating is accomplished by a phenomenon known as electrophoresis, wherein particles dispersed in a fluid move under the influence of an electric field. Electrophoretic coating production lines are typically only capable of coating to a maximum thickness of about 0.01 inch (25.4 micrometers) due to the fact that as the paint thickness builds, electrical resistance increases due to the insulative properties of the coating. As a result, the increasing thickness of the coating decelerates and becomes negligible as the electrical resistance becomes high enough to prevent electrophoresis of the parts disposed in a plating tank.

However, when parts are preprocessed prior to electrophoretic coating with metal media such as iron beads, the parts, when electrophoretically coated using standard cycling times, standard electrophoretic coating equipment, conventional electrophoretic coating compositions, and typical electrophoretic coating process parameters, is capable of achieving conventional coating thicknesses of up to 1 mil with conductive asperities still protruding through the coating material, thus allowing additional coating of the same material or coating of a different material to an overall thickness that is in excess of those that can be obtained without the pretreatment. Due to the decreased electrical resistance from the protruding asperities, the part being electrophoretically coated may be held in the tank longer to increase (e.g., double) its thickness with the same electrophoretic materials. Also, since the first electrophoretic coating can leave the surface highly conductive (i.e., still capable of accepting electrophoretic coating), the parts may be removed, cured, and then further coated at another electrophoretic coating line with a different material to provide a laminated system. Alternatively, if desired, the electrophoretic coating tank dwell time can be increased to significantly increase the thickness of the plated electrophoretic coating film over that of a standard thickness achieved using conventional techniques without the pretreatment step of the invention. This provides an effective, low-cost method of providing a thick, highly protective film that is not otherwise possible using the same materials, equipment and process parameters.

As an alternative to developing thicker electrophoretic coatings and/or multiple layer phoretic coatings, the techniques of the invention may be used for preparing electrophoretically coated parts having conventional electrophoretic coating thicknesses, but which parts have electrically conductive surfaces by virtue of the numerous microscopic metallic points of contact that appear at the surface of the electrophoretic coating.

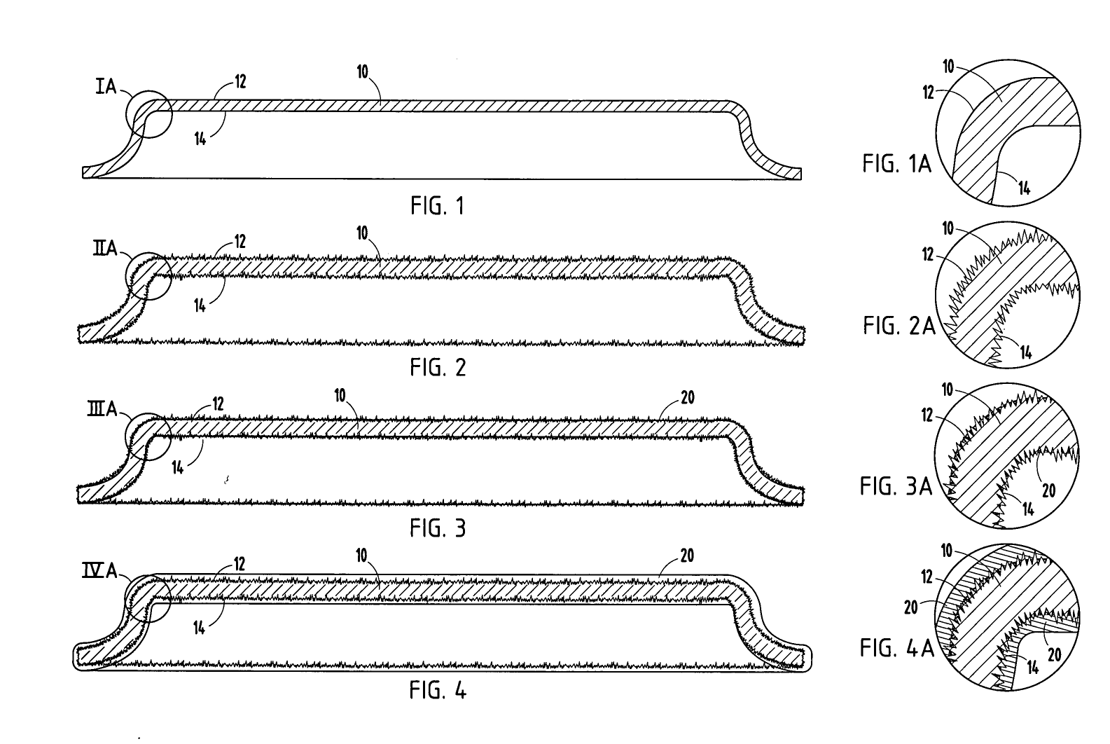

Shown in FIG. 1 is a conventional part 10 having surfaces 12 and 14 that are to be provided with an electrophoretic coating. Part 10 is comprised of an electrically conductive material (e.g., steel).

As shown in FIG. 2, the part is treated in accordance with the invention by blasting the surfaces of the part with a metal media to create a rough surface having asperities with a root mean square height that is more than 0.001 inches in height. Suitable metal media include iron beads or the like.

As shown in FIG. 3, part 10 may be subjected to a conventional electrophoretic coating technique that deposits material 20 from an electrophoretic coating composition within interstices at the surface of the part, providing an electrophoretically coated part having a multitude of asperities having microscopic points exposed through the coating. The part shown in FIG. 3 can be used substantially as it is after a conventional oven curing process to provide a part having an electrophoretically coated surface that is also electrically conductive. Alternatively, the part shown in FIG. 3 can be removed from the electrophoretic bath, subjected to oven curing, and returned to a different electrophoretic bath for coating of a different lamina or layer that can provide a different aesthetic or functional characteristic than the first layer. Finally, as another alternative, the part shown in FIG. 3 can be retained in the electrophoretic bath for a longer period of time to develop a thicker than conventional coating, while using conventional electrophoretic coating processes, process parameters and electrophoretic coating compositions.

Stated differently, the pretreatment process of the invention involving the development of asperities having a height greater than 0.01 inches (1 mil or 25.4 micrometers) allows the development of thicker coatings than could otherwise be achieved using the same materials, equipment, and process parameters, and allows the development of electrically conductive electrophoretically coated surfaces without the need for custom or specially formulated electrophoretic compositions.

With respect to the embodiments of the invention in which microscopic surfaces of asperities are exposed through an electrophoretic coating, the surface, in addition to being electrically conductive, provides improved thermal conductivity when mated to heat sinks.

In accordance with various aspects of the invention, the deposition of electrophoretic coating materials on the treated surfaces having a high asperity also provides a more tenacious mechanical bond between the substrate and the electrophoretic coating, making the coating more resistant to peeling.

With respect to certain aspects of the invention, thicker electrophoretic coatings can be achieved, such as thicknesses in excess of 1 mil, and up to about 2 mils.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A process for electrophoretic coating of an electrically conductive substrate, comprising:
providing an electrically conductive substrate that is to be electrophoretically coated;
pretreating the substrate surface to increase its asperity; and
applying an electrophoretic coating composition to the treated substrate surface.

2. The method of claim 1, in which the electrophoretic coating process is controlled to expose a plurality of microscopic asperity surfaces, thereby providing an electrically conductive surface.

3. The process of claim 1, in which the pretreatment results in asperities having a root means square height of at least 1 mil.

4. The process of claim 1, in which the electrophoretic coating is deposited to a thickness in excess of 1 mil.

5. The process of claim 1, in which the electrophoretic coating is deposited to a thickness of at least 2 mils.

6. The process of claim 1, in which multiple layers of electrophoretic material are deposited, the multiple layers having different functional and/or aesthetic properties.

7. The process of claim 1, in which the pretreatment of the substrate surface to increase its asperity is achieved by blasting the surface with a metal medium.

8. The process of claim 7, in which the metal media are iron beads.

9. An electrophoretically coated part comprising:
an electrically conductive substrate having asperities with a root means square height of at least 1 mil; and
electrophoretic coating deposited on the surface.

10. The part of claim 9, in which the electrophoretic coating has a thickness that is controlled to expose a plurality of the asperities through the coating surface, thereby providing an electrically conductive surface.

11. The part of claim 9, in which the coating has a thickness in excess of 1 mil.

12. The part of claim 9, in which the coating has a thickness of at least 2 mils.

13. The part of claim 9, in which the coating comprises a plurality of different layers having different functional and/or aesthetic properties.
